(19) United States
(12) Patent Application Publication
(10) Pub. No.: US 2010/0052606 A1
(43) Pub. Date: Mar. 4, 2010

(54) CHARGING DEVICE, PORTABLE ELECTRONIC DEVICE EMPLOYING THE SAME, AND CHARGING METHOD THEREOF

(75) Inventor: HSING-YUAN HSIEH, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/546,792

(22) Filed: Aug. 25, 2009

(30) Foreign Application Priority Data
Sep. 1, 2008 (CN) 200810304327.2

(51) Int. Cl. H01M 10/46

(52) U.S. Cl. 320/101

(57) ABSTRACT

A charging device includes an electric energy generating module and a voltage regulating module electrically connected to the electric energy generating module and a battery. The electric energy generating module is configured for collecting and converting heat energy into electric energy, and outputting an voltage. The voltage regulating module receives the electric energy and regulates the output voltage of the electric energy into a stable voltage, and then the electric energy is outputted to charge the battery.

### BACKGROUND

1. Technical Field

The disclosure generally relates to charging devices, particularly, to a charging device used in a portable electronic device, and a method of operating the same.

2. Description of Related Art

Portable electronic devices, such as mobile telephones and personal digital assistants (PDAs), generally are equipped with rechargeable batteries. When battery power is low or empty, a power source is required to recharge the battery.

However, when power sources are not available, the portable electronic devices may not be recharged. In addition, the charger is usually separate component from the portable electronic device.

Therefore, there is a room for improvement within the art.

### BRIEF DESCRIPTION OF THE DRAWINGS

Many aspects of a charging device, a portable electronic device employing the same, and a charging method thereof can be better understood with reference to the following drawings. The components in the drawings are not necessarily to scale, the emphasis instead being placed upon clearly illustrating the principles of the present charging device, portable electronic employing the device, and charging method thereof. Moreover, in the drawings, like reference numerals designate corresponding parts throughout the several views.

FIG. 1 is a block diagram of a charging device charging a battery, according to an exemplary embodiment.

FIG. 2 is a diagram of a portable electronic device with the charging device shown in FIG. 1.

FIG. 3 is flow chart of a method of employing the charging device shown in FIG. 1.

FIG. 4 is a diagram of a charging device and a portable electronic device, in accordance with another embodiment.

### DETAILED DESCRIPTION OF THE EMBODIMENTS

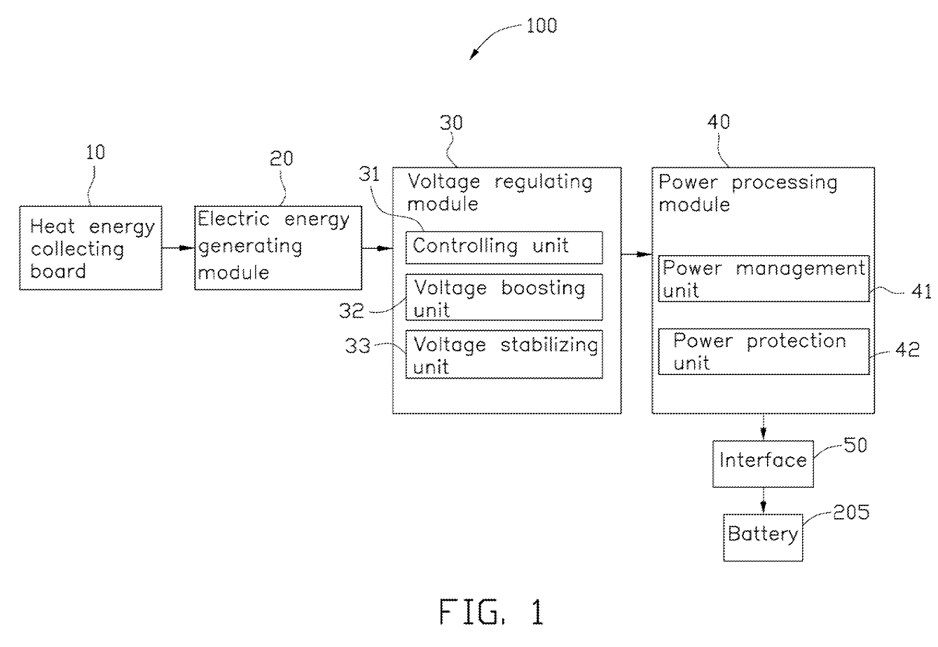

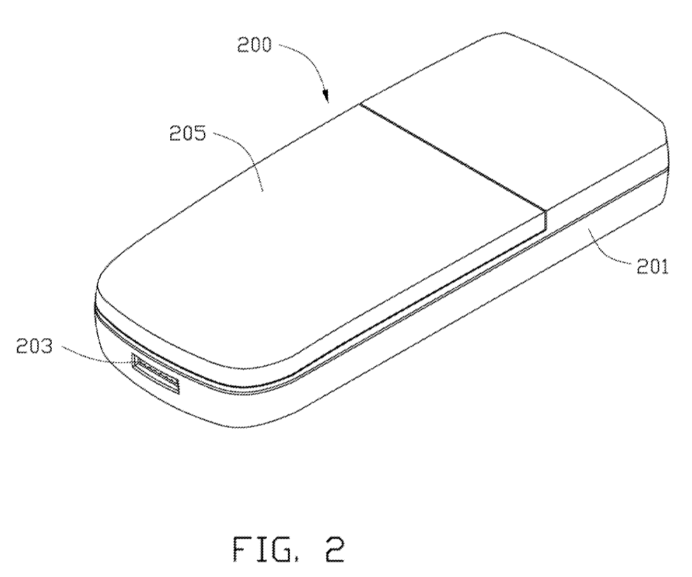

FIGS. 1-2 show an exemplary embodiment of a charging device 100 used to charge a portable electronic device 200, such as a mobile phone. The charging device 100 is installed in the portable electronic device 200. The portable electronic device 200 includes a main body 201, a charging socket 203, and a battery 205. The charging socket 203 is formed at one end of the main body 201, and the battery 205 is located in the main body 201. The charging socket 203 can be configured for connecting with a charging device to charge the battery 205.

The charging device 100 includes a heat energy collecting board 10, an electric energy generating module 20, a voltage regulating module 30, a power processing module 40, and an interface 50. The electric energy generating module 20, the voltage regulating module 30, the power processing module 40 and the interface 50 are electrically connected in series.

The heat energy collecting board 10 is made from aluminum oxide or other materials. The heat energy collecting board 10 is located inside the main body 201 and adjacent to electrical components, such as a motherboard, to collect heat. The heat energy collecting board 10 is configured for absorbing heat from outside or the inside of the portable electronic device 200. The electric energy generating module 20 may be an existing thermoelectric cooler (TEC) chip, such as a TES1-049.39, a TES1-031.39 etc, which can absorb and convert heat energy from the heat energy collecting board 10 into electric energy, and output a voltage. A metal cover (not shown) can be set outside the electric energy generating module 20, the metal used to conduct heat generated by the electric energy generating module 20 to prevent the electric energy generating module 20 from overheating.

The voltage regulating module 30 is configured to receive the electric energy and regulate the output voltage into a stable voltage, and includes a controlling unit 31, a voltage boosting unit 32, and a voltage stabilizing unit 33. The controlling unit 31 can control and activate the voltage boosting unit 32 and the voltage stabilizing unit 33 according to the output voltage from the electric energy generating module 20. When the output voltage is less than an operating voltage, the controlling unit 31 controls the voltage boosting unit 32 to increase the output voltage. When the output voltage is greater than or equal to the operating voltage, the controlling unit 31 controls the voltage stabilizing unit 33 to regulate and stabilize the output voltage into stable voltage.

The power processing module 40 includes a power management unit 41 and a power protection unit 42. The power management unit 41 is configured for controlling the battery 205 to be charged or not, and processing current from the voltage regulating module 30. When the battery 205 is fully charged, the power management unit 41 stops charging the battery 205. The power protection unit 42 is configured for preventing the battery 205 from damage due to abnormal states, such as short circuit, high temperature, abnormal current, etc. The power processing module 40 is electrically connected with the battery 205 via the interface 50.

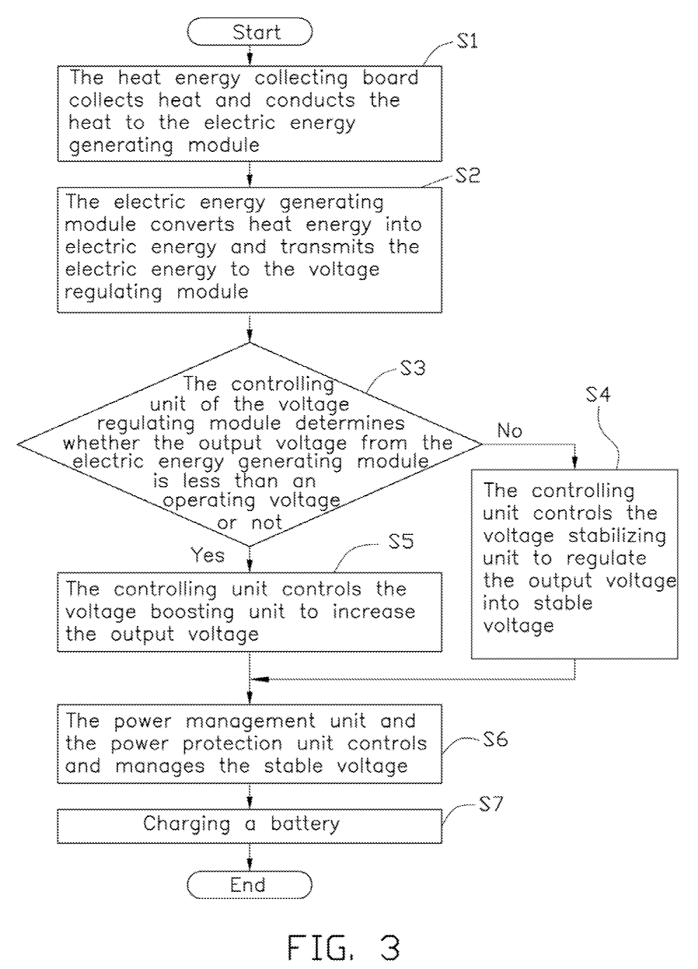

Referring to FIG. 3, the process of the charging device 100 charging the battery 205 of the portable electronic device 200 may include the following steps:

In step S1, the heat energy collecting board 10 collects heat from inside or outside of the portable electronic device 200, and conducts the heat to the electric energy generating module 20.

In step S2, the electric energy generating module 20 converts heat energy into electric energy, and transmits the electric energy to the voltage regulating module 30.

In step S3, the controlling unit 31 of the voltage regulating module 30 determines whether the output voltage from the electric energy generating module 20 is less than an operating voltage or not. If the output voltage is greater than or equal to the operating voltage, the process goes to step S4, and if the output voltage is less than the operating voltage, the process goes to step S5.

In step S4, the controlling unit 31 controls the voltage stabilizing unit 33 to regulate the output voltage into a stable operating voltage.

In step S5, the controlling unit 31 controls the voltage boosting unit 32 to increase the output voltage to the operating voltage.

In step S6, the power management unit 41 and the power protection unit 42 of the power processing module 40 manages the stable operating voltage to prevent the battery 205 from overcharging and other potential damages.

In step S7, charging the battery 205.

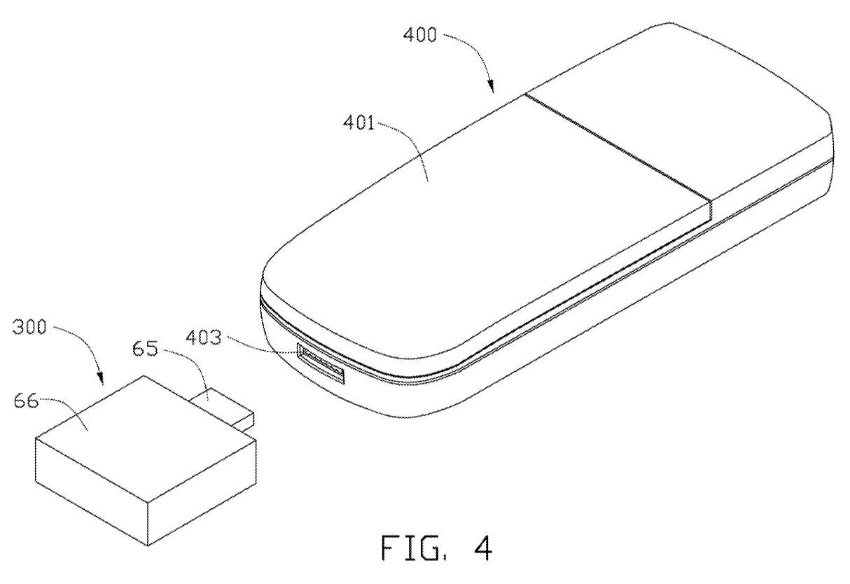

The charging device may be independently and be directly mounted to the portable electronic device. Referring to FIG. 4, a charging device 300 can be mounted to a portable electronic device 400, according to another embodiment. The charging device 300 includes a plug connector 65 and a cover 66. The portable electronic device 400 includes a battery 401 and a charging socket 403 formed at one end of the portable electronic device 400.

The charging device 300 has substantially same configuration as that of the charging device 100 as shown in FIG. 1. The interface 50 is set in the plug connector 65. When the plug connector 65 is inserted into the charging socket 403, the charging device 300 is electrically connected to the battery 401 via the plug connector 65.

Another battery can be set in the charging device to store electric energy when the battery of the portable electronic device is fully charged. In practical use, the charging device utilizes heat energy released by the portable electronic device so as to prolong the use time of the battery.

It is to be understood, however, that the plug connector 65 may be an universal asynchronous receiver/transmitter (UART), a universal serial bus (USB) etc.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A charging device, comprising:
an electric energy generating module configured for receiving and converting heat energy into electric energy, and outputting a voltage; and
a voltage regulating module electrically connected with the electric energy generating module and a battery, wherein the voltage regulating module receives the electric energy and regulates the output voltage into a stable operating voltage, the electric energy outputted to charge the battery.

2. The charging device as claimed in claim 1, further comprising a heat energy collecting board adjacent to the electric energy generating module, the heat energy collecting board used to collect and absorb heat energy.

3. The charging device as claimed in claim 1, further comprising a power processing module; wherein the electric energy generating module, the voltage regulating module, and the power processing module are electrically connected in series.

4. The charging device as claimed in claim 3, wherein the power processing module comprises a power management unit configured for processing current from the voltage regulating module and preventing the battery from overcharging.

5. The charging device as claimed in claim 3, wherein the power processing module further comprises a power protection unit configured for protecting the battery.

6. The charging device as claimed in claim 1, wherein the voltage regulating module comprises a controlling unit and a voltage boosting unit; when the voltage from the electric energy generating module is less than an operating voltage, the controlling unit controls the voltage boosting unit to increase the output voltage to an operating voltage.

7. The charging device as claimed in claim 6, wherein the voltage regulating module further comprises a voltage stabilizing unit; when the voltage from the electric energy generating module is greater than or equal to the operating voltage, the controlling unit controls the voltage stabilizing unit to regulate the output voltage to the stable operating voltage.

8. The charging device as claimed in claim 3, further comprising an interface electrically connected with the power processing module and the battery, wherein the charging device charges the battery via the interface.

9. A charging method, comprising steps of:
collecting and absorbing heat energy;
converting the heat energy into electric energy and outputting a voltage;
regulating and converting the output voltage into a stable operating voltage; and
outputting the stable voltage.

10. The charging method as claimed in claim 9, wherein the step of regulating and converting the output voltage into a stable operating voltage comprises:
determining whether the output voltage is less than an operating voltage or not;
stabilizing the output voltage into a stable operating voltage when the output voltage is greater than or equal to the operating voltage; and
boosting and regulating the output voltage when the output voltage is less than the operating voltage.

11. The charging method as claimed in claim 9, wherein the charging method further comprises a step of processing current and managing the stable voltage after the step of regulating and converting the output voltage into a stable operating voltage.

12. A portable electronic device, comprising:
a main body;
a battery mounted to the main body, the battery supplying electric energy for the portable electronic device; and
a charging device mounted with the main body, the charging device comprising:
an electric energy generating module configured for receiving and converting heat energy into electric energy, and outputting a voltage; and
a voltage regulating module electrically connected with the electric energy generating module and a battery, wherein the voltage regulating module receives the electric energy and regulates the output voltage into a stable operating voltage, the electric energy outputted to charge the battery.

13. The portable electronic device as claimed in claim 12, wherein the charging device further comprises a heat energy collecting board adjacent to the electric energy generating module, and the heat energy collecting board is used to collect and absorb heat energy.

14. The portable electronic device as claimed in claim 12, wherein the charging device further comprises a power processing module; the electric energy generating module, the voltage regulating module, and the power processing module are electrically connected in series.

15. The portable electronic device as claimed in claim 14, wherein the power processing module comprises a power management unit configured for processing current from the voltage regulating module and preventing the battery from overcharging.

16. The portable electronic device as claimed in claim 14, wherein the power processing module further comprises a power protection unit configured for protecting the battery.

17. The portable electronic device as claimed in claim 12, wherein the voltage regulating module comprises a controlling unit and a voltage boosting unit; when the voltage from the electric energy generating module is less than an operating voltage, the controlling unit controls the voltage boosting unit to increase the output voltage to an operating voltage.

18. The portable electronic device as claimed in claim 17, wherein the voltage regulating module further comprises a voltage stabilizing unit; when the voltage from the electric energy generating module is greater than or equal to the operating voltage, the controlling unit controls the voltage stabilizing unit to regulate the output voltage to the stable operating voltage.

19. The portable electronic device as claimed in claim 12, further comprising a charging socket formed at one end of the main body for electrically connected with the charging device.

20. The portable electronic device as claimed in claim 19, wherein the charging device further comprises a plug connector electrically connected with the power processing module, and the plug connector is matched with the charging socket to charge the battery.
